(19) United States
(12) Patent Application Publication
(10) Pub. No.: US 2026/0073927 A1
(43) Pub. Date: Mar. 12, 2026

(54) METHOD, APPARATUS, DEVICE AND STORAGE MEDIUM OF TRAINING A MUSIC COMPRESSION SYSTEM

(71) Applicants: Beijing Zitiao Network Technology Co., Ltd., Beijing (CN); Lemon Inc., Grand Cayman (KY)

(72) Inventors: Lamtharn HANTRAKUL, Beijing (CN); Yi REN, Singapore (SG); Qingqing HUANG, Los Angeles, CA (US); Janne Jayne Harm Renèe SPIJKERVET, Los Angeles, CA (US); Shuo ZHANG, Beijing (CN); Yiqing LU, Beijing (CN); Zhongyi HUANG, Beijing (CN); Andrew Tateh SHAW, Los Angeles, CA (US); Jitong CHEN, Los Angeles, CA (US)

(21) Appl. No.: 19/321,024

(22) Filed: Sep. 5, 2025

(30) Foreign Application Priority Data
Sep. 6, 2024 (CN) 202411253152.2

(51) Int. Cl. G10L 19/04

(52) U.S. Cl. CPC G10L 19/04

(57) ABSTRACT

Embodiments of the disclosue relate to a method, apparatus, device, and storage medium of training a music compression system. The method includes: obtaining a first encoded representation associated with training music content; processing the first encoded representation with the discrete encoder to generate a first set of discrete features corresponding to first music data and a second set of discrete features corresponding to second music data; decoding the first set of discrete features with the first discrete decoder to obtain a first audio feature corresponding to the first music data, and decoding the second set of discrete features with the second discrete decoder to obtain a second audio feature corresponding to the second music data; and determining a training loss based on the first audio feature, the second audio feature and the training music content, and adjusting parameters of the discrete encoder and the discrete decoders based on training loss.

### CROSS-REFERENCE

The present application claims priority to Chinese Patent Application No. 202411253152.2, filed on Sep. 6, 2024 and entitled “METHOD, APPARATUS, DEVICE AND STORAGE MEDIUM OF TRAINING A MUSIC COMPRESSION SYSTEM”, which is incorporated herein by reference.

### FIELD

Example embodiments of the present disclosure generally relate to the field of computers, and in particular, to a method, apparatus, device, and computer-readable storage medium of training a music compression system.

### BACKGROUND

With the continuous progress of deep learning technology, automatic creation and generation of music has gradually progressed from theoretical research to practical applications. In various music processing tasks, encoding music content into discrete features is an important step. The quality of the discrete features will directly affect the results of the music processing task.

### SUMMARY

In a first aspect of the present disclosure, a method of training a music compression system is provided. The method includes: obtaining a first encoded representation associated with training music content; processing the first encoded representation with the discrete encoder to generate a first set of discrete features corresponding to first music data and a second set of discrete features corresponding to second music data; decoding the first set of discrete features with the first discrete decoder to obtain a first audio feature corresponding to the first music data, and decoding the second set of discrete features with the second discrete decoder to obtain a second audio feature corresponding to the second music data; and determining a training loss based on the first audio feature, the second audio feature and the training music content, and adjusting parameters of the discrete encoder and the discrete decoders based on the training loss.

In a second aspect of the present disclosure, an apparatus for training a music compression system is provided. The apparatus includes: an obtaining module, configured to obtain a first encoded representation associated with training music content; an encoding module, configured to process the first encoded representation with the discrete encoder to generate a first set of discrete features corresponding to first music data and a second set of discrete features corresponding to second music data; a decoding module, configured to decode the first set of discrete features with the first discrete decoder to obtain a first audio feature corresponding to the first music data, and decode the second set of discrete features with the second discrete decoder to obtain a second audio feature corresponding to the second music data; and a determining module, configured to determine a training loss based on the first audio feature, the second audio feature and the training music content, and adjust parameters of the discrete encoder and the discrete decoders based on the training loss.

In a third aspect of the present disclosure, an electronic device is provided. The device includes at least one processor; and at least one memory coupled to the at least one processor and storing instructions for execution by the at least one processor. The instructions, when executed by the at least one processor, cause the device to perform the method of the first aspect.

In a fourth aspect of the present disclosure, a non-transitory computer-readable storage medium is provided. The computer-readable storage medium has a computer program stored thereon, and the computer program is executable by the processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description in connection with the accompanying drawings. In the drawings, the same or similar reference numbers refer to the same or similar elements, wherein:

FIG. 1 illustrates a schematic diagram of an example music compression system according to some embodiments of the present disclosure;

FIG. 2 illustrates a flowchart of an example process of training a music compression system according to some embodiments of the present disclosure;

FIGS. 3A-3B illustrate schematic diagrams of an example training process according to some embodiments of the present disclosure;

FIG. 4 illustrates a schematic structural block diagram of an apparatus for training a music compression system according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

As used herein, the term “model” may learn associations between respective inputs and outputs from training data such that corresponding outputs may be generated for a given input after training is complete. The generation of the model may be based on machine learning techniques. Deep learning is a machine learning algorithm that processes inputs and provides corresponding outputs by using a multi-layer processing unit. Herein, “model” may also be referred to as a “machine learning model,” “machine learning network,” or “network,” and these terms are used interchangeably herein. A model may also include different types of processing units or networks.

As used herein, a “unit,” an “operating unit,” or a “subunit” may be composed of a machine learning model or network of any suitable structure. As used herein, a set of elements or similar expressions may include one or more such elements. For example, a “set of convolution units”may include one or more convolution units.

Embodiments of the present disclosure may relate to data of a user, acquisition and/or use of data, and the like. These aspects all follow the corresponding laws and regulations and related rules. In the embodiments of the present disclosure, all data is collected, obtained, processed, manufactured, forwarded, used, etc., all of which are performed on the premise that the user knows and confirms. Accordingly, when implementing the embodiments of the present disclosure, the types, the usage scope, the usage scenario, and the like of the data or information that may be involved, should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, if personal information processing is involved, the processing may be performed on the premise of having a legality basis (for example, obtaining consent of a personal information subject, or necessary for performing a fulfillment of a contract), and the processing is only within a specified or agreed range. The user's rejection on processing the personal information other than necessary information required by the basic function will not affect the user to use the basic function.

In the solution of the present specification and embodiments, if the training and inferencing of the model are involved, the data involved (including but not limited to the data itself, the acquisition and/or use of the data) follows the requirements of the corresponding laws and regulations.

In various music processing tasks, encoding music content into discrete features is an important step. The quality of discrete features will directly affect the results of various music processing tasks (e.g., music generation tasks, etc.).

In view of this, embodiments of the present disclosure provide a solution of training a music compression system. The solution includes: obtaining a first encoded representation associated with training music content; processing the first encoded representation with the discrete encoder to generate a first set of discrete features corresponding to first music data and a second set of discrete features corresponding to second music data; decoding the first set of discrete features with the first discrete decoder to obtain a first audio feature corresponding to the first music data, and decoding the second set of discrete features with the second discrete decoder to obtain a second audio feature corresponding to the second music data; and determining a training loss based on the first audio feature, the second audio feature and the training music content, and adjusting parameters of the discrete encoder and the discrete decoders based on the training loss.

Therefore, by decoupling the features corresponding to different types of music data, the embodiments of the present disclosure can improve the quality of the audio compression, and can ensure the high fidelity and rich music expressiveness of the music signal.

### EXAMPLE SYSTEM

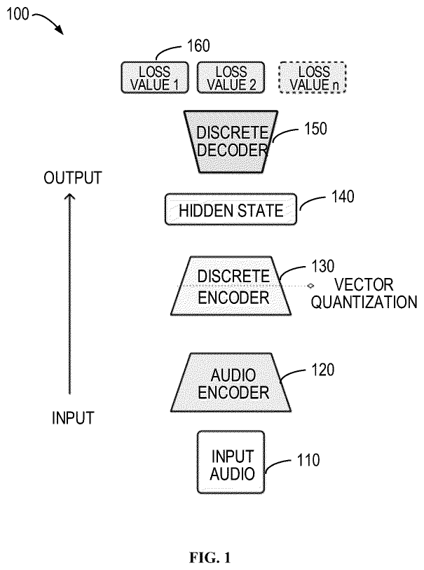

FIG. 1 illustrates a schematic diagram of a music compression system 100 according to some embodiments of the present disclosure. The system 100 may be deployed in a suitable electronic device, or implemented with a suitable electronic device.

In some embodiments, the electronic device may include various types of computing systems/servers capable of providing computing power, and the electronic device may include a terminal device. Such terminal devices may be any type of mobile terminal, fixed terminal, or portable terminal, including mobile phones, desktop computers, laptop computers, notebook computers, netbook computers, tablet computers, media computers, multimedia tablets, personal communication systems (PCS) devices, personal navigation devices, personal digital assistants (PDAs), audio/video players, digital cameras/camcorders, positioning devices, television receivers, radio broadcast receivers, electronic book devices, gaming devices, or any combination of the foregoing, including accessories and peripherals of these devices, or any combination thereof. Electronic devices may include, for example, various types of computing systems/servers capable of providing computing power, such as mainframes, edge computing nodes, computing devices in a cloud environment, virtual machines, and the like. Although shown as a single device, the electronic device may include multiple physical devices.

In some embodiments, the system 100 may also be referred to as a tokenizer, which may be used to process received music content and generate a set of audio encodings of the music content.

As shown in FIG. 1, the system 100 may include an audio encoder 120, a discrete encoder 130, and a discrete decoder 150. During a process of training the system 100, the audio encoder 120 may process input audio 110 to generate an input encoded representation.

Further, the discrete encoder 130 may process the encoded representation to generate a hidden state 140 and may perform a vector quantization process on the hidden state 140.

The discrete decoder 150 may decode the quantization result of the hidden state 140 to generate an output encoded representation. Further, the system 100 may determine various types of losses for training the system 100 based on the output encoded representation to adjust parameters of the discrete encoder 130 and the discrete decoder 150 in system 100.

The overall framework of the system 100 is shown above. As will be described in detail below, the system 100 may also include a plurality of discrete decoders to realize the decoupling of the encoding for different types of music data (e.g., vocal data and accompaniment data).

### EXAMPLE PROCESSES

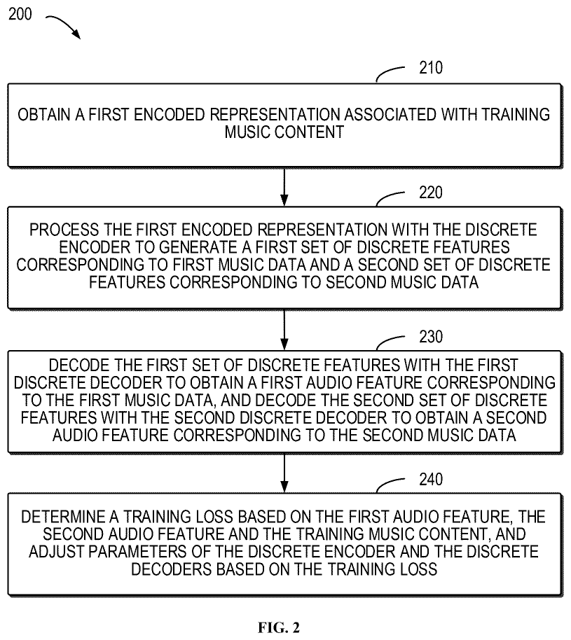

FIG. 2 illustrates a flowchart of an example process 200 of training a music compression system 100 in accordance with some embodiments of the present disclosure. Process 200 may be implemented at the system 100. The process 200 is described below with reference to FIG. 1.

As shown in the figure, at block 210, the system 100 obtains a first encoded representation associated with training music content.

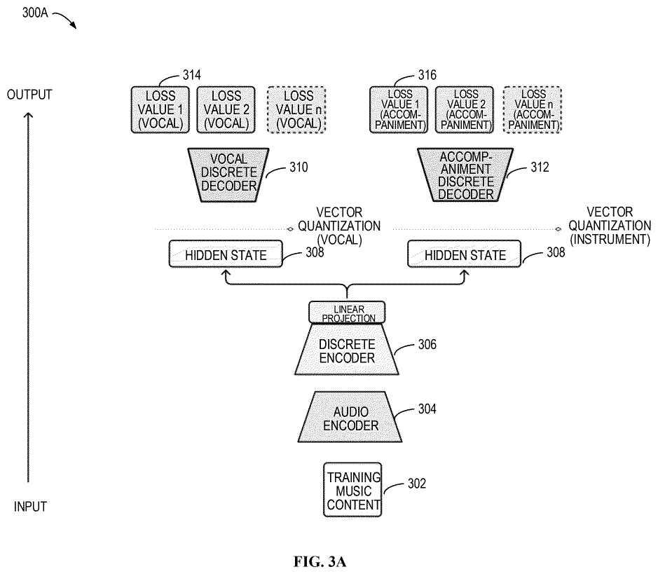

The specific process of training the system 100 will be described below in connection with FIGS. 3A and 3B. FIG. 3A illustrates an example training process according to some embodiments of the present disclosure.

Taking FIG. 3A as an example, the system 100 may encode the training music content 302 with the audio encoder 304 to generate a first encoded representation.

In some embodiments, to improve the locality of audio encoding, the audio encoder 304 may be implemented, for example, based on a convolutional model. Embodiments of the present disclosure may provide the stability of the encoding by implementing the audio encoding with a convolutional model.

In some other embodiments, as shown in FIG. 3B, the system 100 may first perform track separation processing on the training music content 322. Specifically, the system 100 may decompose the training music content 322 into first audio content, e.g., a vocal track 324, corresponding to first music data (e.g., vocal data). The system 100 may also decompose the training music content 322 into second audio content, e.g., an accompaniment track 326, corresponding to the second music data (e.g., accompaniment data). It should be appreciated that, as mentioned above, the training music content 322 (including but not limited to itself, its acquisition and/or use) all complies with the requirements of the corresponding laws and regulations.

Further, the system 100 may encode the first audio content (i.e., the vocal track 324) with the audio encoder 328 to generate a first intermediate encoded representation. The system 100 may also encode the second audio content (i.e., the accompaniment track 326) with the audio encoder 330 to generate a second intermediate encoded representation.

Further, the system 100 may generate a first encoded representation to be processed by the discrete encoder 332 based on the first intermediate encoded representation and the second intermediate encoded representation. For example, the system 100 may sequentially provide the first intermediate encoded representation and the second intermediate encoded representation to the discrete encoder 332. Alternatively, the system 100 may also construct a first encoded representation to be provided to the discrete encoder 332, for example, by combining the first intermediate encoded representation and the second intermediate encoded representation.

With continued reference to FIG. 2, at block 220, the system 100 processes the first encoded representation with the discrete encoder to generate a first set of discrete features corresponding to first music data and a second set of discrete features corresponding to second music data.

With continued reference to the example of FIG. 3A, the system 100 may transform the received first encoded representation into a second encoded representation, e.g., the hidden state 308, with the discrete encoder 306.

Further, system 100 may quantize the second encoded representation (e.g., hidden state 308) into the first set of discrete features based on a first portion of a target codebook associated with the discrete encoder. For example, as shown in FIG. 3A, the system 100 may perform a vector quantization process related to vocal features based on the first portion of the target codebook.

As shown in FIG. 3A, system 100 may also quantize the second encoded representation (e.g., hidden state 308) into the second set of discrete features based on a second portion of a target codebook associated with the discrete encoder. For example, as shown in FIG. 3A, the system 100 may perform a vector quantization process related to the accompaniment feature based on the second portion of the target codebook.

In some embodiments, two portions of the target codebook may be used to maintain vector representations related to vocal features and feature representations related to accompaniment features, respectively. Such a codebook structure may also be referred to as a Conjoined Dual-Codebook.

For the example of FIG. 3B, similar to the process described in FIG. 3A, the system 100 may transform the received first encoded representation into a second encoded representation, e.g., the hidden state 334, with the discrete encoder 332.

Further, system 100 may quantize the second encoded representation (e.g., hidden state 334) into the first set of discrete features based on a first portion of a target codebook associated with the discrete encoder. For example, as shown in FIG. 3B, the system 100 may perform a vector quantization process related to vocal features based on the first portion of the target codebook.

As shown in FIG. 3B, system 100 may also quantize the second encoded representation (e.g., hidden state 334) into the second set of discrete features based on a second portion of a target codebook associated with the discrete encoder. For example, as shown in FIG. 3B, the system 100 may perform a vector quantization process related to the accompaniment feature based on the second portion of the target codebook.

In some embodiments, for the example of FIG. 3B, in a process of generating the first set of discrete features (i.e., discrete features corresponding to the vocal data), the system 100 may, for example, consider only the encoded representations related to the vocal track 324. In a process of generating the second set of discrete features (i.e., discrete features corresponding to the accompaniment data), the system 100 may, for example, consider only the encoded representations related to the accompaniment track 326.

With continued reference to FIG. 2, at block 230, the system 100 decodes the first set of discrete features with the first discrete decoder to obtain a first audio feature corresponding to the first music data, and decodes the second set of discrete features with the second discrete decoder to obtain a second audio feature corresponding to the second music data.

Taking FIG. 3A as an example, the system 100 may include, for example, a vocal discrete decoder 310 (also referred to as a first discrete decoder) and an accompaniment discrete decoder 312 (also referred to as a second discrete decoder).

Further, the vocal discrete decoder 310 may decode the first set of discrete features generated based on the vocal vector quantization process to generate a corresponding vocal audio feature (also referred to as the first audio feature).

The accompaniment discrete decoder 312 may decode the second set of discrete features generated based on the accompaniment vector quantization process to generate a corresponding accompaniment audio feature (also referred to as the second audio feature).

For the example of FIG. 3B, the system 100 may include, for example, a vocal discrete decoder 336 (also referred to as a first discrete decoder) and an accompaniment discrete decoder 338 (also referred to as a second discrete decoder).

Similarly, the vocal discrete decoder 336 may decode a first set of discrete features generated based on a vocal vector quantization process to generate a corresponding vocal audio feature (also referred to as the first audio feature).

The accompaniment discrete decoder 338 may decode a second set of discrete features generated based on the accompaniment vector quantization process to generate a corresponding accompaniment audio feature (also referred to as the second audio feature).

Additionally, as shown in FIG. 3B, the system 100 may also include a mixed audio discrete decoder 340 (also referred to as a third discrete decoder).

The system 100 may construct a third set of discrete features based on the first set of discrete features and the second set of discrete features. For example, the system 100 may mix the first set of discrete features and the second set of discrete features to enable the constructed third set of discrete features to simultaneously characterize the vocal data and the accompaniment data.

Further, the mixed audio discrete decoder 340 may decode the third set of discrete features to generate a third audio feature. The third audio feature may correspond to content of the mixed audio, that is, including both vocal content and accompaniment content.

With continued reference to FIG. 2, at block 240, the system 100 determines a training loss based on the first audio feature, the second audio feature and the training music content, and adjusts parameters of the discrete encoder and the discrete decoders based on the training loss.

As shown in FIG. 3A, the system 100 may determine a first set of losses 314 related to the vocal data based on the first audio feature output by the vocal discrete decoder 310. The system 100 may determine a second set of losses 316 related to the accompaniment data based on the second audio feature output by the accompaniment discrete decoder 312.

In some embodiments, the first set of losses 314 and/or the second set of losses 316 may include an audio reconstruction loss that may be used to characterize a feature difference between an audio signal reconstructed based on the first audio feature or the second audio feature and the original audio signal.

In some embodiments, the first set of losses 314 and/or the second set of losses 316 may include a timbre loss that may be used to characterize a timbre difference between the audio content reconstructed based on the first audio feature or the second audio feature and the reference music content.

In some embodiments, the first set of losses 314 and/or the second set of losses 316 may include speech related losses that may be used to characterize differences between text and/or phonemes identified based on the vocal content of the first audio feature and text and/or phonemes corresponding to the reference music content.

In some embodiments, the first set of losses 314 and/or the second set of losses 316 may include a pitch reconstruction loss that may be used to characterize a pitch difference between the audio content reconstructed based on the first audio feature or the second audio feature and the reference music content.

In some embodiments, the first set of losses 314 and/or the second set of losses 316 may include a perceptual reconstruction loss that may be used to characterize a difference between the audio content reconstructed based on the first audio feature or the second audio feature and the reference music content at the perceptual level (the naturalness level of the music content).

In some embodiments, the first set of losses 314 and/or the second set of losses 316 may include adversarial reconstruction losses that may be used to characterize the loss determined by processing, via a discriminator, the audio content reconstructed based on the first audio feature or the second audio feature and reference music content.

In some embodiments, the first set of losses 314 and/or the second set of losses 316 may include a spectral reconstruction loss that may be used to characterize a spectral difference between the audio content reconstructed based on the first audio feature or the second audio feature and the reference music content.

Accordingly, the system 100 may determine a final training loss based on the first set of losses 314 and the second set of losses 316, thereby adjusting parameters of the discrete encoder 306, the vocal discrete decoder 310, and the accompaniment discrete decoder 312 in the system 100.

In other embodiments, for the example of FIG. 3B, the system 100 may determine the first set of losses 342 related to the vocal data based on the first audio feature output by the vocal discrete decoder 336. The system 100 may determine a second set of losses 344 related to the accompaniment data based on the second audio feature output by the accompaniment discrete decoder 338. Additionally, the system 100 may also determine the third set of losses 346 related to the mixed audio data based on the third audio feature output by the mixed audio discrete encoder 340.

In some embodiments, the type of losses of the first set of losses 342, the second set of losses 344, and/or the third set of losses 346 may be the same as the first set of losses 314 and/or the second set of losses 316 discussed above, and are not repeated herein.

Accordingly, the system 100 may determine the final training loss based on the first set of losses 342, the second set of losses 344, and the third set of losses 346, thereby adjusting parameters of the discrete encoder 332, the vocal discrete decoder 336, the accompaniment discrete decoder 338, and the mixed audio discrete decoder 340 in the system 100.

In some embodiments, although the process of decoupling the different types of music data in the compression process is described above by using the vocal data and the accompaniment data as examples, the embodiments of the present disclosure may also be applied to other types of music data, for example, drum beat data, data of different instruments, and the like.

In some embodiments, the system 100 mentioned above may complete the training based on a single training phase without performing a plurality of training phases such as self-supervised learning, supervised fine-tuning, and supervised fine-tuning based on vector quantization.

In some embodiments, after the training of the audio compression system is completed, the audio compression system 100 may process the target music content with the audio encoder and the corresponding discrete encoder to generate a set of audio encoded representations.

Based on the above process, by decoupling the features corresponding to different types of music data, the embodiments of the present disclosure can improve the quality of the audio compression, and can ensure the high fidelity and rich music expressiveness of the music signal.

### EXAMPLE APPARATUS AND DEVICE

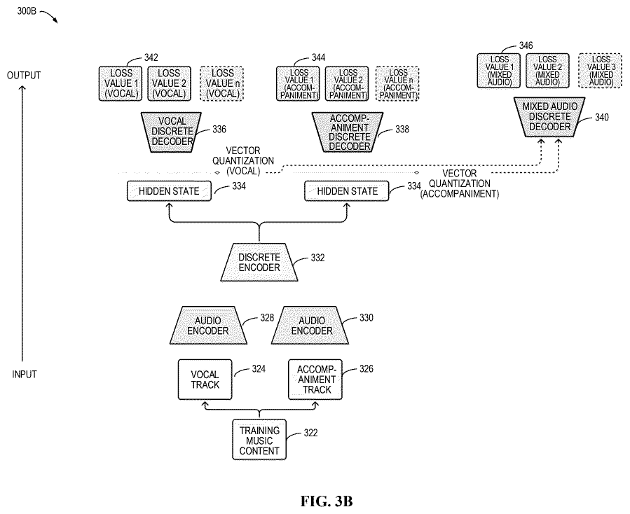

Embodiments of the present disclosure also provide a corresponding apparatus for implementing the above method or process. FIG. 4 illustrates a schematic structural block diagram of an apparatus 400 for training a music compression system according to some embodiments of the present disclosure. The apparatus 400 may be implemented or included in the system 100. The various modules/components in the apparatus 400 may be implemented by hardware, software, firmware, or any combination thereof.

As shown in FIG. 4, the apparatus 400 includes: an obtaining module 410, configured to obtain a first encoded representation associated with training music content; an encoding module 420, configured to process the first encoded representation with the discrete encoder to generate a first set of discrete features corresponding to first music data and a second set of discrete features corresponding to second music data; a decoding module 430, configured to decode the first set of discrete features with the first discrete decoder to obtain a first audio feature corresponding to the first music data, and decode the second set of discrete features with the second discrete decoder to obtain a second audio feature corresponding to the second music data; and a determining module 440, configured to determine a training loss based on the first audio feature, the second audio feature and the training music content, and adjust parameters of the discrete encoder and the discrete decoders based on the training loss.

In some embodiments, the encoding module 420 is further configured to: transform the first encoded representation into a second encoded representation with the discrete encoder; quantize the second encoded representation into the first set of discrete features based on a first portion of a target codebook associated with the discrete encoder; and quantize the second encoded representation into the second set of discrete features based on a second portion of the target codebook associated with the discrete encoder.

In some embodiments, the obtaining module 410 is further configured to: decompose the training music content into first audio content corresponding to the first music data and second audio content corresponding to the second music data; encode the first audio content with a first audio encoder to generate a first intermediate encoded representation; encode the second audio content with a second audio encoder to generate a second intermediate encoded representation; and determine the first encoded representation based on the first intermediate encoded representation and the second intermediate encoded representation.

In some embodiments, the music compression system further includes a third discrete decoder, and the decoding module 430 is further configured to: construct a third set of discrete features based on the first set of discrete features and the second set of discrete features; and decode the third set of discrete features with the third discrete decoder to generate a third audio feature.

In some embodiments, the training loss is determined further based on the third audio feature.

In some embodiments, the training loss comprises at least one of the following: a pitch reconstruction loss, a perceptual reconstruction loss, or an adversarial reconstruction loss.

In some embodiments, the first encoded representation is generated by an audio encoder, and the audio encoder is a convolutional model.

In some embodiments, the first music data is vocal data, and the second music data is accompaniment data.

In some embodiments, the apparatus 400 further includes a processing module, configured to process target music content with the trained audio compression system to generate a set of audio tokens.

The modules included in the apparatus 400 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the modules in the apparatus 400 may be implemented, at least in part, by one or more hardware logic components. By way of example and not limitation, illustrative types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

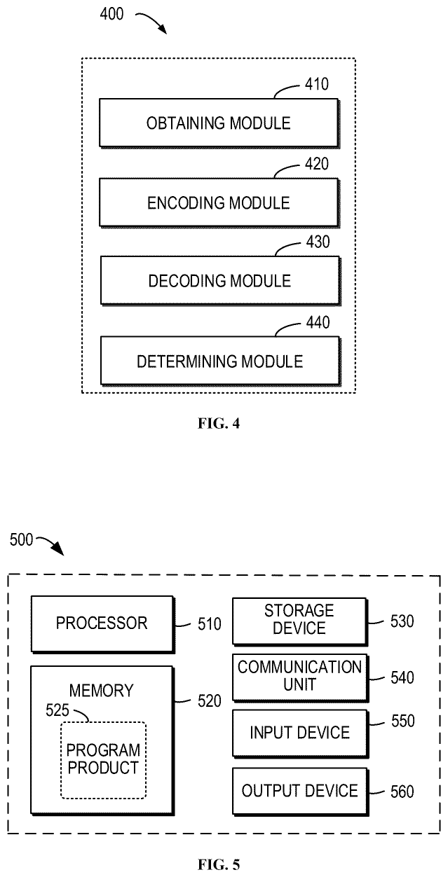

FIG. 5 illustrates a block diagram of an electronic device 500 in which one or more embodiments of the present disclosure may be implemented. It should be understood that the electronic device 500 illustrated in FIG. 5 is merely illustrative and should not constitute any limitation on the functionality and scope of the embodiments described herein. The electronic device 500 shown in FIG. 5 may be configured to implement the system 100 in FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, a plurality of processing units execute computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, magnetic disk, or any other medium, which may be capable of storing information and/or data and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or acts of various embodiments of the present disclosure.

The communication unit 540 is configured to communicate with other electronic devices through a communication medium. Additionally, the functionality of components of the electronic device 500 may be implemented in a single computing cluster or a plurality of computing machines capable of communicating over a communication connection. Thus, the electronic device 500 may operate in a networked environment using logical connections with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product is tangibly stored on a non-transitory computer-readable medium and includes computer-executable instructions, the computer-executable instructions, when executed by a processor, implements the method described above.

Various aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of each block in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce an apparatus for implementing the functions/acts specified in one or more blocks of the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement various aspects of the functions/acts specified in one or more blocks of the flowchart and/or block diagram.

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other device implement the functions/acts specified in one or more blocks of the flowchart and/or block diagram.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or acts, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method of training a music compression system comprising a discrete encoder, a first discrete decoder, and a second discrete decoder, the method comprising:
obtaining a first encoded representation associated with training music content;
processing the first encoded representation with the discrete encoder to generate a first set of discrete features corresponding to first music data and a second set of discrete features corresponding to second music data;
decoding the first set of discrete features with the first discrete decoder to obtain a first audio feature corresponding to the first music data, and decoding the second set of discrete features with the second discrete decoder to obtain a second audio feature corresponding to the second music data; and
determining a training loss based on the first audio feature, the second audio feature and the training music content, and adjusting parameters of the discrete encoder and the discrete decoders based on the training loss.

2. The method of claim 1, wherein processing the first encoded representation with the discrete encoder comprises:
transforming the first encoded representation into a second encoded representation with the discrete encoder;
quantizing the second encoded representation into the first set of discrete features based on a first portion of a target codebook associated with the discrete encoder; and
quantizing the second encoded representation into the second set of discrete features based on a second portion of the target codebook associated with the discrete encoder.

3. The method of claim 1, wherein obtaining the first encoded representation associated with the training music content comprises:
decomposing the training music content into first audio content corresponding to the first music data and second audio content corresponding to the second music data;
encoding the first audio content with a first audio encoder to generate a first intermediate encoded representation;
encoding the second audio content with a second audio encoder to generate a second intermediate encoded representation; and
determining the first encoded representation based on the first intermediate encoded representation and the second intermediate encoded representation.

4. The method of claim 1, wherein the music compression system further comprises a third discrete decoder, and the method further comprises:
constructing a third set of discrete features based on the first set of discrete features and the second set of discrete features; and
decoding the third set of discrete features with the third discrete decoder to generate a third audio feature.

5. The method of claim 4, wherein the training loss is determined further based on the third audio feature.

6. The method of claim 1, wherein the training loss comprises at least one of the following: a pitch reconstruction loss, a perceptual reconstruction loss, or an adversarial reconstruction loss.

7. The method of claim 1, wherein the first encoded representation is generated by an audio encoder, and the audio encoder is a convolutional model.

8. The method of claim 1, wherein the first music data is vocal data, and the second music data is accompaniment data.

9. The method of claim 1, further comprising:
processing target music content with the trained audio compression system to generate a set of audio tokens.

10. An electronic device, comprising:
at least one processor; and
at least one memory coupled to the at least one processor and storing instructions for execution by the at least one processor, wherein the instructions, when executed by the at least one processor, cause the electronic device to perform acts comprising:
obtaining a first encoded representation associated with training music content;
processing the first encoded representation with the discrete encoder to generate a first set of discrete features corresponding to first music data and a second set of discrete features corresponding to second music data;
decoding the first set of discrete features with the first discrete decoder to obtain a first audio feature corresponding to the first music data, and decoding the second set of discrete features with the second discrete decoder to obtain a second audio feature corresponding to the second music data; and
determining a training loss based on the first audio feature, the second audio feature and the training music content, and adjusting parameters of the discrete encoder and the discrete decoders based on the training loss.

11. The electronic device of claim 10, wherein processing the first encoded representation with the discrete encoder comprises:
transforming the first encoded representation into a second encoded representation with the discrete encoder;
quantizing the second encoded representation into the first set of discrete features based on a first portion of a target codebook associated with the discrete encoder; and
quantizing the second encoded representation into the second set of discrete features based on a second portion of the target codebook associated with the discrete encoder.

12. The electronic device of claim 10, wherein obtaining the first encoded representation associated with the training music content comprises:
decomposing the training music content into first audio content corresponding to the first music data and second audio content corresponding to the second music data;
encoding the first audio content with a first audio encoder to generate a first intermediate encoded representation;
encoding the second audio content with a second audio encoder to generate a second intermediate encoded representation; and
determining the first encoded representation based on the first intermediate encoded representation and the second intermediate encoded representation.

13. The electronic device of claim 10, wherein the music compression system further comprises a third discrete decoder, and the acts further comprise:
constructing a third set of discrete features based on the first set of discrete features and the second set of discrete features; and
decoding the third set of discrete features with the third discrete decoder to generate a third audio feature.

14. The electronic device of claim 13, wherein the training loss is determined further based on the third audio feature.

15. The electronic device of claim 10, wherein the training loss comprises at least one of the following: a pitch reconstruction loss, a perceptual reconstruction loss, or an adversarial reconstruction loss.

16. The electronic device of claim 10, wherein the first encoded representation is generated by an audio encoder, and the audio encoder is a convolutional model.

17. The electronic device of claim 10, wherein the first music data is vocal data, and the second music data is accompaniment data.

18. The electronic device of claim 10, wherein the acts further comprise:
processing target music content with the trained audio compression system to generate a set of audio tokens.

19. A non-transitory computer-readable storage medium having a computer program stored thereon, wherein the computer program is executable by a processor to implement acts comprising:
obtaining a first encoded representation associated with training music content;
processing the first encoded representation with the discrete encoder to generate a first set of discrete features corresponding to first music data and a second set of discrete features corresponding to second music data;
decoding the first set of discrete features with the first discrete decoder to obtain a first audio feature corresponding to the first music data, and decoding the second set of discrete features with the second discrete decoder to obtain a second audio feature corresponding to the second music data; and
determining a training loss based on the first audio feature, the second audio feature and the training music content, and adjusting parameters of the discrete encoder and the discrete decoders based on the training loss.

20. The non-transitory computer-readable storage medium of claim 19, wherein processing the first encoded representation with the discrete encoder comprises:
transforming the first encoded representation into a second encoded representation with the discrete encoder;
quantizing the second encoded representation into the first set of discrete features based on a first portion of a target codebook associated with the discrete encoder; and
quantizing the second encoded representation into the second set of discrete features based on a second portion of the target codebook associated with the discrete encoder.
